(19) United States
(12) Patent Application Publication
(10) Pub. No.: US 2023/0357482 A1
(43) Pub. Date: Nov. 9, 2023

(54) Copolymer having polyamide blocks and having polyether blocks for the manufacture of a foamed article

(71) Applicant: ARKEMA FRANCE, Colombes (FR)

(72) Inventors: Blandine TESTUD, Serquigny (FR); Quentin PINEAU, Serquigny (FR)

(73) Assignee: ARKEMA FRANCE, Colombes (FR)

(21) Appl. No.: 18/245,260

(22) PCT Filed: Jan. 31, 2022
(86) PCT No.: PCT/FR2022/050166

§ 371 Date: Mar. 14, 2023

(30) Foreign Application Priority Data
Feb. 1, 2021 (FR) FR2100968

(51) Int. Cl. C08F 293/00; C08J 9/18; C08J 9/12; C08J 9/232; B29C 43/00; B29C 44/34

(52) U.S. Cl. CPC C08F 293/00; C08J 9/18; C08J 9/122; C08J 9/232; B29C 43/003; B29C 44/3461; C08J 2203/06; C08J 2353/00; B29B 7/005

(57) ABSTRACT

The present invention relates to a copolymer having polyamide blocks and having polyether blocks (PEBA) which can be used for the manufacture of an article, preferably a foamed article. The invention also relates to expanded particles prepared from said copolymer and to the manufacture of a foamed article from said expanded particles.

### FIELD OF THE INVENTION

The present invention relates to a copolymer having polyamide blocks and having polyether blocks (PEBA) which can be used for the manufacture of an article, preferably a foamed article. The invention also relates to expanded particles prepared from said copolymer and to the manufacture of a foamed article from said expanded particles.

### TECHNICAL BACKGROUND

It is known to use copolymers having polyamide blocks and having polyether blocks and more advantageously foamed articles prepared from copolymers of this type in the field of sports equipment, such as soles or sole components, gloves, rackets or golf balls, personal protection items, in particular for practising sports (jackets, interior parts of helmets, of shells, and the like), by virtue of their mechanical properties and their lightness.

Foamed articles (also referred to as “foam articles”) can be prepared by different foaming technologies, including injection moulding or extrusion processes, the “autoclave” method or also techniques starting from expanded particles (foam beads).

More particularly, the preparation of expanded particles can be carried out according to different processes, for example:
the document U.S. 2016/0121524 describes a “foaming-extrusion” process for the manufacture of expanded particles of a thermoplastic elastomer, comprising a stage of extrusion of the molten thermoplastic elastomer comprising a physical blowing agent, such as CO₂ or N₂;
the document U.S. 2016/0297943 describes a process for the manufacture of expanded particles by the “autoclave” method, comprising a stage of impregnation of the granules of thermoplastic elastomers in a gaseous medium at a specific temperature and a specific pressure, and a stage of blowing at a reduced pressure with respect to the pressure applied during the impregnation stage.

The production of foamed, often moulded, articles starting from expanded particles generally involves the assembling of these expanded particles by fusion, such as that described in WO 16030333, where the expanded particles were joined together in a mould by supplying thermal energy in order to obtain a foamed and moulded article (e.g. footwear soles). This supply of thermal energy can be provided by a stream of pressurized steam, electromagnetic radiation or microwave radiation. Under the effect of the pressure and the temperature, the expanded particles are partially melted at the surface, making possible the interdiffusion of polymer chains between neighbouring expanded particles, thus ensuring their adhesion. Good cohesion of the expanded particles, and also a low content of macrovoids, are necessary in order to ensure good mechanical properties for the foamed and moulded articles.

The document EP 3 053 732 describes a process for the manufacture of foamed articles by assembling expanded particles under electromagnetic radiation.

However, it is not always easy to prepare a foamed article from expanded particles, in particular in the case where the assembling of these expanded particles takes place by moulding. This is because, during the forming, the expanded particles are not always capable of perfectly matching the shape of the mould with a predetermined shape, in particular when the shape is complex.

To attempt to solve this problem, a high pressure can be applied to “force” the expanded particles to match the shape of the mould but this generally results in an increase in the density and in the destruction of the good mechanical strength of the moulded articles as a result of the crushing of the expanded particles during the assembling. It is also possible to increase the temperature in order to further melt the particles but this generally induces surface defects in the moulded articles.

The document JP 2016188342 describes an article foamed by moulding. It states that it is possible to improve the property of fusion between the expanded particles by decreasing the crystallinity of the surface layer of the particles. For this, it provides for the impregnation of a crystallinity inhibitor of phenolic compound type on the surface of the particles.

A continuous demand exists on the market for ever lighter and more effective foamed articles, namely foamed articles with improved properties in terms of density and of homogeneity, while retaining mechanical properties required for a final application.

It is thus an aim of the present invention to provide copolymers having polyamide blocks and having polyether blocks which make it possible to prepare foamed articles, preferably from expanded particles manufactured from said copolymers, with low densities, improved homogeneites and good mechanical properties, such as the rebound capacity, low compression set, the ability to withstand repeated impacts without deforming and ability to return to the initial shape.

### SUMMARY OF THE INVENTION

According to a first aspect, the present invention relates to a copolymer having polyamide blocks and having polyether blocks (PEBA), suitable for the preparation of expanded particles, exhibiting:
a crystallinity such that the enthalpy of fusion, measured by DSC during the second heating at a rate of 20° C./minute according to Standard ISO 11357-3 (Δ Hm(2)), is equal to or greater than 15 J/g, this melting corresponding to that of the amide units,
a Vicat softening temperature (VST) of greater than or equal to 75° C. and less than or equal to 120° C. according to Standard ISO 306 (method A50).

The present invention provides a specific copolymer making possible the formation of a foamed article from said copolymer which is uniform and homogeneous, exhibiting a low density and having one or more advantageous properties from among: a high capacity for restoring elastic energy during low-stress loadings; a low compression set (and thus an improved durability), a high fatigue strength in compression; excellent resilience properties, and in particular abrasion resistance.

The enthalpy of fusion is preferably equal to or greater than 18 J/g, more preferentially still equal to or greater than 20 J/g.

The Vicat softening temperature is preferably greater than or equal to 80° C., more preferentially still equal to or greater than 90° C., and preferably less than or equal to 115° C., more preferentially still less than or equal to 110° C.

According to one embodiment, the polyamide blocks of the PEBA copolymer are copolyamide blocks.

According to one embodiment, the polyamide blocks of the PEBA copolymer are chosen from the polyamide blocks resulting from the condensation of an α,ω-aminocarboxylic acid or of a lactam, preferably chosen from the PA 11 or PA 12 blocks, said copolymer having a number-average molar mass (Mn) of the polyamide blocks of 400 to 1500 g/mol, more preferentially of 500 to 1200 g/mol and more preferentially still of 500 to 1000 g/mol and/or a number-average molar mass (Mn) of the polyether blocks of 400 to 2000 g/mol, more preferentially of 500 to 1500 g/mol and more preferentially still of 500 to 1000 g/mol.

The copolymer can have an instantaneous hardness of less than or equal to 72 Shore D, more preferably of less than or equal to 55 Shore D, more preferably of less than 45 Shore D.

According to another aspect, the invention relates to expanded particles of the copolymer as is described below.

It has been observed in the context of the present invention, during a stage of assembling by moulding, that these particular expanded particles easily match the shape of the mould, making it possible to prepare foamed articles of complex shape.

Thus, the present invention provides expanded particles manufactured from specific PEBA copolymers, having an improved mouldability for the manufacture of a foamed article by moulding, while retaining the good mechanical properties demanded, such as are mentioned above, and an improved lightness.

According to another aspect, the present invention relates to an article, preferably a foamed article, comprising at least one element consisting of a PEBA copolymer as defined above or expanded particles described above.

The article can be chosen from footwear soles, in particular sports footwear soles, large or small balls, gloves, personal protection equipment, tie pads, motor vehicle parts, structural parts and electrical and electronic equipment parts.

The present invention also relates to a process for the preparation of foamed articles by moulding, comprising a stage of assembling the expanded particles in a mould.

The invention is now described in detail and in a nonlimiting way in the description which follows.

### DESCRIPTION OF THE INVENTION

### Definition

In the present description of the invention, including in the examples below:
the Vicat softening temperatures (VST) are measured according to Standard ISO 306: 2013 (method A50);
the densities of the expanded particles or of the foamed articles are measured according to Standard ISO 845: 2009;
the number-average molar masses Mn are measured by size exclusion chromatography (or gel permeation chromatography) according to ISO 16014-1:2012. The product is solubilized in hexafluoroisopropanol stabilized with 0.05 M potassium trifluoroacetate for 24 h at ambient temperature at a concentration of 1 g/l. The solution obtained is subsequently filtered through a PTFE membrane with a porosity of 0.2 μm, then injected at a flow rate of 1 ml/min into a liquid chromatography system equipped with a set of PFG columns from Polymer Standards Service consisting of a pre-column with dimensions of 50×8 mm, of a 1000 Å column, with dimensions of 300×8 mm and a particle size of 7 μm, and of a 100 Å column, with dimensions of 300×8 mm and a particle size of 7 μm. The molar masses are measured by the refractive index and are expressed as PMMA equivalents (PMMA being used as calibration standard);
The instantaneous hardnesses of the PEBA copolymer are measured according to Standard ISO 868:2003;
the resiliences by ball rebound of the foamed articles are measured according to Standard ISO 8307:2007;
the compression sets of the foamed articles are measured according to Standard ISO 7214: 2012, with a deformation of 50%, a maintenance time of 6 h at a temperature of 50° C., and while carrying out a first measurement after 30 minutes and a second measurement after 24 h of recovery.
the nomenclature used to denote the polyamides follows Standard ISO 1874-1. In particular, in the PA “Z” notation, Z represents the number of carbon atoms of the polyamide units resulting from the condensation of an amino acid or lactam. In the PA “XY” notation denoting a polyamide resulting from the condensation of a diamine with a dicarboxylic acid, X represents the number of carbon atoms of the diamine and Y represents the number of carbon atoms of the dicarboxylic acid. The PA Z/XY, PA Z/Z′, PA Z/XY/X′Y′, PA Z/Z′/XY, PA Z/Z′/XY/X′Y′, and the like, notation relates to copolyamides in which XY, Z, X′Y′, Z′, and the like, represent XY or Z homopolyamide units as described above, X′Y′ being identical to or different from XY and Z′ being identical to or different from Z;
the D50 sizes, referred to here as “volume median diameter”, are measured according to Standard ISO 9276-2:2014.

### Copolymer Having Polyamide Blocks and Having Polyether Blocks (PEBA)

The copolymer having polyamide blocks and having polyether blocks of the present invention can preferably be a linear (non-crosslinked) copolymer.

The PEBA copolymers can result from the polycondensation of polyamide (PA) blocks having reactive ends with polyether (PE) blocks having reactive ends, such as:
1) polyamide blocks having diamine chain ends with polyoxyalkylene blocks having dicarboxyl chain ends;
2) polyamide blocks having dicarboxyl chain ends with polyoxyalkylene blocks having diamine chain ends;
3) polyamide blocks having dicarboxyl chain ends with polyetherdiols, the products obtained being, in this specific case, polyetheresteramides.

The polyamide blocks having dicarboxyl chain ends originate, for example, from the condensation of polyamide precursors in the presence of a chain-limiting dicarboxylic acid. The polyamide blocks having diamine chain ends originate, for example, from the condensation of polyamide precursors in the presence of a chain-limiting diamine.

Two types of polyamide blocks can advantageously be used.

According to a first type (of the PA Z/XY, PA Z/Z′, PA Z/XY/X′Y′, PA Z/Z′/XY, PA Z/Z′/XY/X′Y′, and the like, type), the polyamides blocks are copolyamide blocks.

These blocks can be obtained, for example, by condensation of one or more α,ω-aminocarboxylic acids or lactams, and of at least one diamine and at least one dicarboxylic acid.

According to an alternative form, the polyamide blocks result from the condensation of at least two α,ω-aminocarboxylic acids or of at least two lactams having from 6 to 12 carbon atoms or of a lactam and of an α,ω-aminocarboxylic acid with a different number of carbon atoms.

Mention may be made, as examples of α,ω-aminocarboxylic acids, of α,ω-aminocarboxylic acids having from 4 to 12 carbon atoms, and in particular aminocaproic acid, 7-aminoheptanoic acid, 11-aminoundecanoic acid and 12-aminododecanoic acid. Mention may be made, as examples of lactams, of lactams having from 6 to 12 carbon atoms, and in particular caprolactam, oenantholactam and lauryllactam. The PA 6, PA 11 and PA 12 blocks, and also their mixtures, are particularly preferred.

As examples of dicarboxylic acids, the dicarboxylic acid can comprise from 4 to 36, preferably from 6 to 18, carbon atoms. It is preferably an aliphatic, in particular linear, cycloaliphatic or aromatic dicarboxylic acid.

Preferably, it is an aliphatic, in particular linear, dicarboxylic acid. Mention may be made, as examples, of butanedioic acid, adipic acid, azelaic acid, suberic acid, sebacic acid, dodecanedicarboxylic acid, octadecanedicarboxylic acid, terephthalic acid and isophthalic acid, and dimerized fatty acids. These dimerized fatty acids preferably have a dimer content of at least 98%; preferably, they are hydrogenated; they are, for example, the products sold under the Pripol® trademark by Croda or under the Empol® trademark by BASF or under the Radiacid® trademark by Oleon, and polyoxyalkylene-α,ω-diacids.

As examples of diamines, the diamine can comprise in particular from 2 to 20, preferably from 6 to 14, carbon atoms. Mention may be made, as examples, of tetramethylenediamine, 1,5-pentanediamine, 2-methylpentane-1,5-diamine, hexamethylenediamine, 1,10-decamethylenediamine, dodecamethylenediamine, trimethylhexamethylenediamine, the isomers of bis(4-aminocyclohexyl)methane (BACM), bis(3-methyl-4-aminocyclohexyl)methane (BMACM), and 2,2-bis(3-methyl-4-aminocyclohexyl)propane (BMACP), and para-aminodicyclohexylmethane (PACM), and isophoronediamine (IPDA), 2,6-bis(aminomethyl)norbornane (BAMN) and piperazine (Pip).

The homopolyamide units (of the PA “XY” type) originate from the condensation of a dicarboxylic acid with an aliphatic, cycloaliphatic or aromatic diamine, preferably an aliphatic diamine.

PA 66, PA 610, PA 612, PA 1010, PA 1012, PA 1014, and also their mixtures, are preferred.

According to this first type, the PA 6/11, PA 6/12, PA 11/12, PA 6/11/12, PA 6/66/12, PA 6/1010, PA 6/1012, PA 6/1010/1012, PA 6/1012/12, PA 6/66/11/12 and PA 6/1010/1012/1014 blocks, and also their mixtures, are particularly preferred.

According to a second type, the polyamide blocks (of the PA “Z” type) result from the condensation of an α,ω-aminocarboxylic acid or of a lactam.

The α,ω-aminocarboxylic acids and lactams can be chosen in particular from those listed above for the polyamide blocks of the first type. The PA 11 and PA 12 blocks are particularly preferred.

These polyamide blocks can be prepared by polycondensation of the monomers in the presence of an appropriate chain-limiting agent. Such chain-limiting agents are, for example, dicarboxylic acids and diamines, as mentioned above. Consequently, it is possible to use, as chain-limiting agent, the dicarboxylic acid or the diamine employed as monomer, which is introduced in excess. In the case of polycondensation of α,ω-aminocarboxylic acids or of lactams, a chain-limiting agent can be added to the monomers. Mention may also be made of dimerized fatty acids. These dimerized fatty acids preferably have a dimer content of at least 98%; preferably, they are hydrogenated; they are, for example, the products sold under the Pripol® trademark by Croda or under the Empol® trademark by BASF or under the Radiacid® trademark by Oleon, and polyoxyalkylene-α,ω-diacids.

The polyether blocks of the PEBA comprise essentially or consist of alkylene oxide units. The polyether blocks can result from alkylene glycols, such as PEG (polyethylene glycol), PPG (polypropylene glycol), PO3G (polytrimethylene glycol) or PTMG (polytetramethylene glycol), preferably PTMG.

They can also result from copolyethers comprising different alkylene oxides distributed in the chain uniformly, in particular in blocks, or randomly.

The polyether blocks can also be obtained by oxyethylation of bisphenols, such as bisphenol A. These products are described in particular in the document EP 613 919 A1. The polyether blocks can also be ethoxylated primary amines, such as the products of formula:

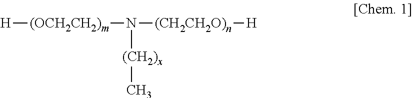

in which m and n are integers between 1 and 20 and x is an integer between 8 and 18. These products are, for example, commercially available under the Noramox® trade name from CECA and under the Genamin® trade name from Clariant.

The polyether blocks can finally comprise or consist of polyoxyalkylene blocks having NH₂ chain ends, it being possible for such blocks to be obtained by cyanoacetylation of polyetherdiols. Such polyethers are sold by Huntsman under the Jeffamine® or Elastamine® name (for example, Jeffamine® D400, D2000, ED 2003 or XTJ 542).

A method for the two-stage preparation of PEBAs having ester bonds between the PA blocks and the PE blocks is described in the document FR 2 846 332 A1. A method for the preparation of PEBAs having amide bonds between the PA blocks and the PE blocks is described in the document EP 1 482 011 A1. The polyether blocks can also be mixed with polyamide precursors and a diacid chain-limiting agent in order to prepare PEBAs by a one-stage process.

While the PEBAs generally comprise a polyamide block and a polyether block, they can also comprise two, three, four, indeed even more, different blocks chosen from those described.

According to one embodiment, the preferred PEBA copolymers are the copolymers comprising copolyamide blocks and blocks resulting from PTMG, for example: PA 6/11 and resulting from PTMG, PA 6/12 and resulting from PTMG, PA 11/12 and resulting from PTMG, PA 6/11/12 and resulting from PTMG, PA 6/66/12 and resulting from PTMG, PA 6/1010 and resulting from PTMG, PA 6/1012 and resulting from PTMG, PA 6/1010/1012 and resulting from PTMG, or PA 6/1012/12 and resulting from PTMG.

According to the embodiment where the polyamide blocks of the PEBA copolymer are copolyamide blocks, the number-average molar mass (Mn) of the polyamide blocks in the PEBA copolymer is from 400 to 20 000 g/mol, more preferentially from 500 to 10 000 g/mol, preferentially from 500 to 4000 g/mol and more preferentially still from 600 to 2000 g/mol. For example, the number-average molar mass of the polyamide blocks in the PEBA copolymer can be from 400 to 1000 g/mol, or from 1000 to 1500 g/mol, or from 1500 to 2000 g/mol, or from 2000 to 2500 g/mol, or from 2500 to 3000 g/mol, or from 3000 to 3500 g/mol, or from 3500 to 4000 g/mol, or from 4000 to 5000 g/mol, or from 5000 to 6000 g/mol, or from 6000 to 7000 g/mol, or from 7000 to 8000 g/mol, or from 8000 to 9000 g/mol, or from 9000 to 10 000 g/mol, or from 10 000 to 11 000 g/mol, or from 11 000 to 12 000 g/mol, or from 12 000 to 13 000 g/mol, or from 13 000 to 14 000 g/mol, or from 14 000 to 15 000 g/mol, or from 15 000 to 16 000 g/mol, or from 16 000 to 17 000 g/mol, or from 17 000 to 18 000 g/mol, or from 18 000 to 19 000 g/mol, or from 19 000 to 20 000 g/mol.

According to this embodiment, the number-average molar mass (Mn) of the polyether blocks is from 100 to 6000 g/mol, more preferentially from 200 to 3000 g/mol and more preferentially still from 200 to 2000 g/mol. The number-average molar mass of the polyether blocks can be from 100 to 200 g/mol, or from 200 to 500 g/mol, or from 500 to 800 g/mol, or from 800 to 1000 g/mol, or from 1000 to 1500 g/mol, or from 1500 to 2000 g/mol, or from 2000 to 2500 g/mol, or from 2500 to 3000 g/mol, or from 3000 to 3500 g/mol, or from 3500 to 4000 g/mol, or from 4000 to 4500 g/mol, or from 4500 to 5000 g/mol, or from 5000 to 5500 g/mol, or from 5500 to 6000 g/mol.

According to the embodiment where the polyamide blocks of the PEBA copolymer are chosen from polyamide blocks resulting from the condensation of an α,ω-aminocarboxylic acid or lactam (of the PA “Z” type), the number-average molar mass (Mn) of the polyamide blocks in the PEBA copolymer is preferably from 400 to 1500 g/mol, more preferentially from 500 to 1200 g/mol and preferentially from 500 to 1000 g/mol. For example, the number-average molar mass (Mn) of the polyamide blocks in the PEBA copolymer can be from 400 to 600 g/mol, or from 600 to 900 g/mol, or from 900 to 1000 g/mol, or from 1000 to 1200 g/mol, or from 1200 to 1300 g/mol, or from 1300 to 1400 g/mol, or from 1400 to 1500 g/mol.

According to this embodiment, the number-average molar mass (Mn) of the polyether blocks is preferably from 400 to 1500 g/mol, more preferentially from 500 to 1200 g/mol and more preferentially still from 500 to 1000 g/mol. For example, the number-average molar mass of the polyether blocks can be from 400 to 600 g/mol, or from 600 to 900 g/mol, or from 900 to 1000 g/mol, or from 1000 to 1200 g/mol, or from 1200 to 1300 g/mol, or from 1300 to 1400 g/mol, or from 1400 to 1500 g/mol.

According to this embodiment, the preferred PEBA copolymers are the copolymers comprising polyamide blocks resulting from the condensation of an α,ω-aminocarboxylic acid or of a lactam and blocks resulting from PTMG, for example: PA 11 and resulting from PTMG, PA 12 and resulting from PTMG, and their mixtures.

The number-average molar mass (Mn) is set by the content of chain-limiting agent. It can be calculated according to the relationship:

Mₙ=nₘₒₙₒₘₑᵣ×M_{w repeat unit}/n_{chain-limiting agent}+M_{w chain-limiting agent}

In this formula, nₘₒₙₒₘₑᵣ represents the number of moles of monomer, n_{chain-limiting agent} represents the number of moles of chain-limiting agent (for example diacid) in excess, M_{w repeat unit} represents the molar mass of the repeat unit and M_{w chain-limiting agent} represents the molar mass of the chain-limiting agent (for example diacid) in excess.

According to one embodiment, the proportion by weight of polyether blocks in the copolymer is at least 50%, with respect to the total weight of the copolymer.

Preferably, the proportion by weight of polyether blocks is from 55% to 85%, with respect to the total weight of the copolymer, and more preferentially from 60% to 80%, with respect to the total weight of the copolymer.

The proportions by weight of blocks in the copolymer can be determined from the number-average molar masses of the blocks.

The PEBA copolymer of the present invention can contain at least one usual additive, such as heat stabilizers (e.g. antioxidant, UV stabilizer), glass fibres, carbon fibres, a flame retardant, talc, a nucleating agent, a plasticizer, a colourant, a fluorinated agent, a lubricant or a stearate, such as zinc stearate, calcium stearate or magnesium stearate.

The PEBA copolymer can be at least partially obtained from biobased raw materials. The term “raw materials of renewable origin” or “biobased raw materials” is understood to mean materials which comprise biobased carbon or carbon of renewable origin. Specifically, unlike materials resulting from fossil substances, materials composed of renewable starting materials contain ¹⁴C. The “content of carbon of renewable origin” or “content of biobased carbon” is determined by application of Standards ASTM D 6866 (ASTM D 6866-06) and ASTM D 7026 (ASTM D 7026-04). By way of example, the PEBAs comprising PA 11 blocks originate, at least in part, from biobased raw materials and exhibit a content of biobased carbon of at least 1%, which corresponds to a ¹²C/¹⁴C isotopic ratio of at least 1.2×10⁻¹⁴. Preferably, the PEBAs comprise at least 50% by weight of biobased carbon relative to the total weight of carbon, which corresponds to a ¹²C/¹⁴C isotopic ratio of at least 0.6×10⁻¹². This content is advantageously higher, in particular up to 100%, which corresponds to a ¹²C/¹⁴C isotopic ratio of 1.2×10⁻¹², in the case, for example, of PEBA having PA 11 blocks and PE blocks comprising PTMG resulting from raw materials of renewable origin.

### Expanded Particles

The copolymers having polyamide blocks and having polyether blocks as defined above can be used to prepare expanded particles.

The expanded particles according to the present invention preferably exhibit a density of less than or equal to 200 kg/m³, or better still of less than or equal to 150 kg/m³, more preferentially of less than or equal to 100 kg/m³. Control of the density can be achieved by an adaptation of the parameters of its manufacturing process by a person skilled in the art.

The expanded particles can comprise one or more polymers other than the PEBA copolymer as described above, for example polyamides, functional polyolefins, copolyetheresters, thermoplastic polyurethanes (TPUs), copolymers of ethylene and of vinyl acetate (for example the products sold under the Evatane® trademark by SK Functional Polymer), or copolymers of ethylene and of acrylate, or copolymers of ethylene and of alkyl (meth)acrylate (for example the products sold under the Lotryl® trademark by SK Functional Polymer). These additives can make it possible to adjust the hardness of the particles, their appearance and their comfort. The additives can be added in a content of from 0% to 50% by weight, preferentially from 5% to 30% by weight, with respect to the total weight of the PEBA copolymer.

The expanded particles can also comprise one or more additives, such as pigments (TiO₂ and other compatible coloured pigments), adhesion promoters (for improving the adhesion of the expanded foam to other materials), fillers (for example calcium carbonate, barium sulfate and/or silicon oxide), nucleating agents (in pure form or in concentrated form, for example CaCO₃, ZnO, SiO₂ or combinations of two or more of them), rubbers (for improving the rubber elasticity, such as natural rubber, SBR, polybutadiene and/or ethylene/propylene terpolymer), stabilizers, for example antioxidants, UV absorbers and/or flame retardants and processing aids, for example stearic acid. The additives can be added preferably in a content of from 0% to 10% by weight, with respect to total weight of the PEBA copolymer.

The expanded particles according to the invention can be used to manufacture sports equipment, such as sports footwear soles, ski footwear, midsoles, insoles, or else functional sole components, in the form of inserts in the various parts of the sole (for example the heel or the arch), or else footwear upper components in the form of reinforcements or inserts into the structure of the footwear upper, in the form of protections.

They can also be used to manufacture large balls, sports gloves (for example football gloves), golf ball components, rackets, protective elements (jackets, interior elements of helmets, of shells, and the like).

They can also be used for the manufacture of railway tie pads, or of various parts in the motor vehicle industry, in transport, in electrical and electronic equipment, in the building industry or in the manufacturing industry.

The expanded particles can be prepared according to processes known to a person skilled in the art.

By way of example, the expanded particles can be prepared by a manufacturing process comprising an impregnation stage and a blowing stage.

The impregnation stage can be carried out in water (“wet impregnation”), in which PEBA copolymer as defined above, in the form of granules, is mixed with a dispersant, optionally one or more polymers other than the PEBA copolymer and/or one or more additives as described above, in an autoclave. Subsequently, stirring is applied, typically at temperature and under pressure, in order to obtain a dispersion, and the blowing agent is introduced under pressure into the dispersion, the blowing agent thus impregnated into the granules of the copolymers.

The dispersant can be calcium phosphate, magnesium pyrophosphate, sodium pyrophosphate and magnesium oxide, or a surfactant, such as sodium dodecylbenzenesulfonate.

Alternatively, the impregnation stage can be carried out by the introduction of the blowing agent under pressure into the granules of copolymers in an autoclave, in order to obtain the granules impregnated with the blowing agent (“dry impregnation”).

The blowing stage generally comprises a stage of reduction in the pressure, making it possible for the gas generated by the blowing agent to dissipate in order to produce the expanded particles of the copolymer.

The expanded particles can also be prepared by an extrusion process, comprising a stage of melt extrusion of a mixture of the PEBA copolymer as defined above, in the form of granules, with optionally one or more polymers other than the PEBA copolymer and/or one or more additives as described above, and a blowing agent, for example, in an extruder, bringing about the foaming of said mixture directly at the extrusion die outlet, it being possible for the expanded particles to be recovered in the cooling water during the granulation.

The blowing agent can be a chemical or physical agent, or also a mixture of these. Preferably, it is a physical agent, for example aliphatic hydrocarbons, such as butane, alicyclic hydrocarbons, such as cyclobutane, and inorganic gases, such as carbon dioxide, nitrogen and air.

The physical blowing agent can be mixed with the copolymer in liquid or supercritical form and then converted into the gaseous phase during the foaming stage. The physical blowing agent may remain present in the pores of the foam, in particular if it is a closed-pore foam, and/or may dissipate.

The chemical blowing agent is an agent which generates a gas by chemical reaction or pyrolysis. Examples comprise azodicarbonamide or mixtures based on citric acid and on sodium hydrogen carbonate (NaHCO₃) (such as the products sold under the Hydrocerol® trade name by Clariant).

The expanded particles thus formed consist essentially, indeed even consist, of the copolymer described above (or the mixture, if a mixture of polymers is used) and optionally the one or more additives which are dispersed in the matrix. In the case where a chemical blowing agent is employed, the foamed article can comprise, in addition to the copolymer described above (or the mixture, if a mixture of polymers is used), the decomposition products of the chemical blowing agent, said products being dispersed in the matrix.

The expanded particles can typically have a spherical, ellipsoidal or triangular shape. Preferably, the expanded particles have a spherical shape, which can have a mean size D50 of between 2 and 20 mm, preferably from 2 to 10 mm.

The expanded particles of the present invention can be recycled, for example by melting them in an extruder equipped with a degassing outlet (optionally after having chopped them up into pieces).

### Article

The article, preferably the foamed article, comprises at least one element consisting of a PEBA copolymer as defined above or expanded particles described above.

The article, preferably the foamed article, can be chosen from sports equipment, such as sports footwear soles, ski footwear, midsoles, insoles, or else functional sole components, in the form of inserts in the various parts of the sole (for example the heel or the arch), or else footwear upper components in the form of reinforcements or inserts into the structure of the footwear upper, in the form of protections.

It can also be chosen from large balls, sports gloves (for example football gloves), golf ball components, rackets, protective elements (jackets, interior elements of helmets, of shells, and the like). It can also be chosen from railway tie pads, or various parts in the motor vehicle industry, in transport, in electrical and electronic equipment, in the building industry or in the manufacturing industry.

According to one embodiment, the article, preferably the foamed article, is chosen from footwear soles, in particular sports footwear soles, large or small balls, gloves, personal protection equipment, tie pads, motor vehicle parts, structural parts and electrical and electronic equipment parts.

The article, preferably the foamed article, can comprise one or more polymers other than the PEBA copolymer and/or one or more additives, chosen in particular from those listed above for the expanded particles.

The foamed article according to the present invention preferably exhibits a density of less than or equal to 200 kg/m³, or better still of less than or equal to 180 kg/m³, more preferentially of less than or equal to 150 kg/m³. Preferably, the foamed article exhibits a resilience by ball rebound of greater than or equal to 50%, preferably of greater than or equal to 60%.

Preferably, the foamed article exhibits a compression set of less than or equal to 50%, and more particularly preferably of less than or equal to 45%, or less than or equal to 40%, or less than or equal to 35%.

Another advantage of the article, preferably the foamed article, of the present invention is to provide better adhesion to the other elements in order to facilitate complex assembling. This is particularly advantageous in the production of multilayer structures by overmoulding processes, for example in the context of the preparation of a footwear sole which is often in the form of multilayers.

The foamed article of the present invention can be prepared preferably by a moulding process, for example by compression moulding of the expanded particles or injection moulding starting from the copolymers in the form of granules.

According to one embodiment, the foamed article of the present invention is prepared by assembling the expanded particles as are described above in a mould.

The assembling stage can be carried out by hot pressing using a press at temperature and/or steam-chest compression moulding of the expanded particles in a mould. Reference may be made to the paper “Past and present developments in polymer bead foams and bead foaming technology” by Daniel Raps et al. (Polymer, 56 (2015), 5-19) for the steam-chest compression moulding technology. The steam pressure and/or temperature conditions depend on the PEBA copolymer constituting the expanded particles and can be adjusted by a person skilled in the art.

A binder can be used appropriately to promote the assembling of the expanded particles. Examples of binder comprise surface modifiers, such as urethanes. These binders can be used alone or in combination. Preferably, the binders can be used during the hot pressing.

According to a preferential embodiment, the preparation of the expanded particles and the preparation of the foamed articles from the latter can be carried out in one and the same item of equipment, preferably in a mould.

Thus, the process for the preparation of a foamed article comprises:
a stage of impregnation in a mould of a PEBA copolymer as described above, in the form of granules, with a blowing agent, optionally one or more polymers other than the copolymer and/or one or more additives;
a blowing stage in order to produce the expanded particles of the copolymer; and
a stage of assembling the expanded particles in order to form the foamed article in the mould, the blowing and assembling stages taking place simultaneously.

The invention is concerned in particular with the preparation of the foamed articles by assembling the expanded particles. However, it would not be departing from the scope of the invention to prepare the foamed articles by foam injection moulding starting from the PEBA copolymers in the form of granules.

The process can comprise a stage of injection of a mixture comprising the PEBA copolymer as defined above, in the form of granules, optionally one or more polymers other than the PEBA copolymer and/or one or more additives as are described above, and a blowing agent into a mould and a stage of foaming said mixture. The foaming is produced either during the injection into the mould of a volume of polymer less than that of the mould, or by the opening of the mould. These two techniques, each or in combination, make it possible to directly produce, from the granules of the copolymers, three-dimensional foamed objects with complex geometries.

Other foam injection moulding techniques which can be used in the context of the present invention are in particular foam injection moulding with a breathing mould, with application of a gas back pressure, under metering, or with a mould equipped with a Variotherm® system.

The foamed article according to the present invention can be recycled, for example by melting it in an extruder equipped with a degassing outlet (optionally after having chopped it up into pieces).

The invention will be further explained in a nonlimiting way with the help of the Example which follows.

### EXAMPLES

### Example 1

Materials used: Table 1 shows the different raw materials employed and their respective suppliers. All the compounds were used as received.

TABLE 1

| Raw material | Supplier |
|---|---|
| 6-Aminocaproic acid (amino 6) | Sigma-Aldrich |
| 11-Aminoundecanoic acid (amino 11) | Arkema |
| 12-Aminododecanoic acid (amino 12) | Arkema |
| Adipic acid | Sigma-Aldrich |
| PTMG 650, PTMG 1000 and PTMG 2000 | BASF |
| PEG 1500 | Clariant |

The compounds PTMG 650, PTMG 1000 and PTMG 2000 are products sold under the names PolyTHF® 650, PolyTHF® 1000 and PolyTHF® 2000.

PEBA copolymers: different PEBA copolymers were prepared. The natures and the number-average molar masses (Mn) of the polyamide (PA) blocks and polyether (PE) blocks of Examples A to D and Counterexamples E to G appear in Table 2 below.

TABLE 2

| | | |
|---|---|---|
| Nature of the | Nature of the | |
| PA | PE | Mn PE (g/mol) |

| | |
|---|---|
| PA 11 | PTMG |
| PA 11/12 | PTMG |
| PA 11/12 | PEG |
| PA 12 | PTMG |
| PA 11/12 | PTMG |
| PA 12 | PTMG |
| PA 6/11/12 | PTMG |

When the PA block is copolymerized, the proportion by weight of each constituent of the amide unit is specified. For example, Example B refers to a PEBA copolymer, the PA block of which consists of a PA 11/12 copolyamide (PA 11/12 ratio by weight:

Preparation process: the PEBA copolymers were synthesized according to the following protocol.

Case of Example A: 35.02 g of amino 11, 9.25 g of adipic acid and 40 g of PTMG 650 are charged into a 300 ml glass tube connected to an anchor stirrer and a condenser. The assembly is rendered inert for 30 minutes under a stream of nitrogen and then heated to a temperature of 240° C. Stirring is started as soon as the reaction medium can be stirred. After one hour under a stream of nitrogen, the reaction medium is gradually placed under vacuum, where the catalyst is introduced. The progression of the reaction is ensured by the monitoring of the motor torque: the reaction is terminated when a torque of 20 N/cm is reached at 60 rpm. Then the vacuum is cut off and the stirring and the heating are halted. The reaction medium is subsequently placed under nitrogen during its cooling. All the syntheses were stabilized by 0.16 g of antioxidant and catalysed by 0.59 ml of zirconium butoxide (Zr(OBu)₄) diluted in butanol. Examples B to G were prepared and adapted according to protocols of Example A with amounts presented in Table 3.

TABLE 3

| Amino | Amino | Amino | Adipic | PTMG | PTMG | PTMG | PEG |
|---|---|---|---|---|---|---|---|
| 6 | 11 | 12 | acid | 650 | 1000 | 2000 | 1500 |
| | 35.02 | | 9.25 | | | | |
| | 24.51 | 12.26 | 5.74 | | | | |
| | 13.96 | 24.44 | 3.79 | | | | |
| | | 37.95 | 5.95 | | | | |
| | 36.01 | 10.51 | 4.58 | | | | |
| | | 15.71 | 4.63 | | | 61.54 | |
| 20.34 | 26.92 | 32.38 | 12.28 | 11.18 | | | |

Table 4 shows the Vicat softening temperatures (T_{VST}) and enthalpies of fusion measured for each of the PEBA copolymers A to G and also the aptitude for overmoulding of the expanded particles obtained from said PEBA copolymers in a process of assembling by steam-chest compression moulding.

The expanded particles are prepared according to the following method.

Case of Example F: 100 g of granules are impregnated by CO₂ in an autoclave reactor at a pressure of 170 bar and a temperature of 135° C. for 4 hours. This dry impregnation stage is followed by a stage of blowing of the gas dissolved in the PEBA resin by reduction in the pressure down to ambient pressure. After cooling the reactor, the expanded PEBA particles can be collected. The conditions of impregnation of the CO₂ depend on the copolymer constituting the expanded particles and can be adjusted by a person skilled in the art.

Examples A to E and G were prepared and adapted according to protocols of Example F.

TABLE 4

| | | |
|---|---|---|
| | Enthalpy of fusion | Mouldability of the |
| T_{VST} (° C.) | (ΔHf, J/g) | expanded particles |

good
good
good
good
poor
poor
poor

Examples A to D and Counterexamples E to G show that a PEBA copolymer exhibiting a Vicat softening temperature of between 75° C. and 120° C. and a minimum crystallinity as defined by the DSC measurement of the enthalpy of fusion of the amide units during the second heating at a rate of 20° C./minute, i.e. of greater than or equal to 15 J/g, confers an improved mouldability on the expanded particles produced from said PEBA copolymer.

1. Copolymer having polyamide blocks and having polyether blocks (PEBA), suitable for the preparation of expanded particles, exhibiting:
a crystallinity such that the enthalpy of fusion, measured by DSC during the second heating at a rate of 20° C./minute according to Standard ISO 11357-3 (ΔHm(2)), is equal to or greater than 15 J/g, this melting corresponding to that of the amide units,
a Vicat softening temperature (VST) of greater than or equal to 75° C. and less than or equal to 120° C. according to Standard ISO 306 (method A50).

2. Copolymer according to claim 1, in which the polyamide blocks of the PEBA copolymer are copolyamide blocks.

3. Copolymer according to claim 1, in which the polyamide blocks are blocks chosen from the PA 6/11, PA 6/12, PA 11/12, PA 6/11/12, PA 6/66/12, PA 6/1010, PA 6/1012, PA 6/1010/1012, PA 6/1012/12, PA 6/66/11/12 and PA 6/1010/1012/1014 blocks, and also their mixtures.

4. Copolymer according to claim 1, in which the polyamide blocks of the PEBA copolymer are chosen from the polyamide blocks resulting from the condensation of an α,ω-aminocarboxylic acid or of a lactam, said copolymer having a number-average molar mass (Mn) of the polyamide blocks of 400 to 1500 g/mol, and/or a number-average molar mass (Mn) of the polyether blocks of 400 to 2000 g/mol.

5. Copolymer according to claim 1, in which the polyether blocks are chosen from blocks resulting from PEG, from PPG, from PO3G and/or from PTMG.

6. Copolymer according to claim 1, having an instantaneous hardness of less than or equal to 72 Shore D.

7. Copolymer according to claim 1, in which the proportion by weight of polyether blocks in the copolymer is at least 50%, with respect to the total weight of the copolymer.

8. Expanded particles of a copolymer according to claim 1.

9. Expanded particles according to claim 8, having a spherical, ellipsoidal or triangular shape having a mean size of between 2 and 20 mm.

10. Expanded particles according to claim 8, exhibiting a density of less than or equal to 200 kg/m³.

11. Article comprising at least one element consisting of a copolymer according to claim 1.

12. Article according to claim 11, being chosen from footwear soles, large or small balls, gloves, personal protection equipment, tie pads, motor vehicle parts, structural parts and electrical and electronic equipment parts.

13. Process for the preparation of an article according to claim 11, by moulding.

14. Process according to claim 13, comprising a stage of assembling the expanded particles of the copolymer by hot pressing using a hot press and/or a steam-chest compression moulding in a mould.

15. Process according to claim 13, comprising:
a stage of impregnation in a mould of the copolymer, in the form of granules, with a blowing agent, optionally one or more polymers other than the copolymer and/or one or more additives;
a blowing stage in order to produce the expanded particles of the copolymer; and
a stage of assembling the expanded particles in order to form the foamed article in the mould, the blowing and assembling stages taking place simultaneously.
